(19) United States
(12) Patent Application Publication
(10) Pub. No.: US 2021/0339418 A1
(43) Pub. Date: Nov. 4, 2021

(54) FOOD CUTTING DEVICE

(71) Applicant: Tina V. Tatum, Duluth, GA (US)

(72) Inventor: Tina V. Tatum, Duluth, GA (US)

(21) Appl. No.: 17/103,101

(22) Filed: Nov. 24, 2020

Related U.S. Application Data
(60) Provisional application No. 63/018,809, filed on May 1, 2020.

(51) Int. Cl. B26D 3/24; A21C 15/04; B26D 1/25

(52) U.S. Cl. CPC B26D 3/24; B26D 2210/02; B26D 1/25; A21C 15/04

(57) ABSTRACT

A food cutting device for cutting a food item into a plurality of individual portions having a base portion including a bottom panel with a substantially-planar top surface, a top portion including a housing and a cutting assembly including a plurality of elongated blades, the top portion being pivotably-connected to the base portion, the top portion being movable between an open position and a closed position, wherein the cutting assembly is movable between a first position in which the blades of the cutting assembly extend outwardly from the housing, and a second position in which the blades are disposed entirely within the housing.

### CLAIM OF PRIORITY

This application claims priority to U.S. provisional patent application No. 63/018,809 filed May 1, 2020, the disclosure of which is incorporated by reference herein.

### FIELD OF THE INVENTION

The present invention relates generally to devices for cutting food items. More particularly, the present invention relates to devices for cutting food items into uniformly sized portions.

### BACKGROUND OF THE INVENTION

Most of us are familiar with the common situation where, in ordering and eating a pizza, the size of the pieces may contrast drastically in size. When this occurs, the large pieces are difficult to handle, often resulting in dropped sauce and toppings that can stain clothing and carpet. Furthermore, due to the fact that pizza is often hot, burns can result where the hot cheese, sauce and toppings drop onto one's person. Also, where the pizza serves as a meal for a number of people, the disproportionate pieces make for unequal servings and, as a result, further cutting is required to even-out the meal. From a business point of view, a poorly cut pizza relates directly to quality and workmanship in the food product. Accordingly, there is need for a means by which commercial pizza establishments and restaurants can ensure constant, evenly sliced pizzas on a consistent basis.

Moreover, pizzas are often presented to customers of restaurants on a buffet. Often, the planar surface of the buffet table is heated to keep the pizza warm. However, while being warmed over a period of time, it is fairly common for moisture to leave the pizza, as the pizza is uncovered, leaving the pizza toppings and crust dried out and undesirable for the customers.

The present invention recognizes and addresses considerations of prior art constructions and methods.

### SUMMARY OF THE INVENTION

One embodiment of the present disclosure provides a food cutting device for cutting a food item into a plurality of individual portions, the device including having a base portion including a bottom panel with a substantially-planar top surface, a top portion including a housing and a cutting assembly including a plurality of elongated blades, the top portion being pivotably-connected to the base portion, the top portion being movable between an open position and a closed position, wherein the cutting assembly is movable between a first position in which the blades of the cutting assembly extend outwardly from the housing, and a second position in which the blades are disposed entirely within the housing.

The accompanying drawings, which are incorporated in and constitute a part of this specification, illustrate one or more embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended drawings, in which;

FIG. 1 is a perspective view of an embodiment of a food cutting device in accordance with the present disclosure; and

FIG. 2 is an exploded, perspective view of the food cutting device shown in FIG. 1;

FIGS. 3A and 3B are perspective views of the housing of the food cutting device shown in FIGS. 1 and 2;

FIG. 4 is a front view of the food cutting device shown in FIG. 1;

FIG. 5 is a cross-sectional view of the food cutting device shown in FIG. 4, taken along line 5-5;

FIG. 6 is a perspective view of the blade assembly of the food cutting device shown in FIGS. 3A and 3B;

FIGS. 7A and 7B are perspective and cross-sectional views of an alternate embodiment of a food cutting device in accordance with the present disclosure.

Repeat use of reference characters in the present specification and drawings is intended to represent same or analogous features or elements of the invention according to the disclosure.

### DETAILED DESCRIPTION OF THE PREFERRED EMBODIMENTS

Reference will now be made in detail to presently preferred embodiments of the invention, one or more examples of which are illustrated in the accompanying drawings. Each example is provided by way of explanation, not limitation, of the invention. In fact, it will be apparent to those skilled in the art that modifications and variations can be made in the present invention without departing from the scope and spirit thereof. For instance, features illustrated or described as part of one embodiment may be used on another embodiment to yield a still further embodiment. Thus, it is intended that the present invention covers such modifications and variations as come within the scope of the appended claims and their equivalents.

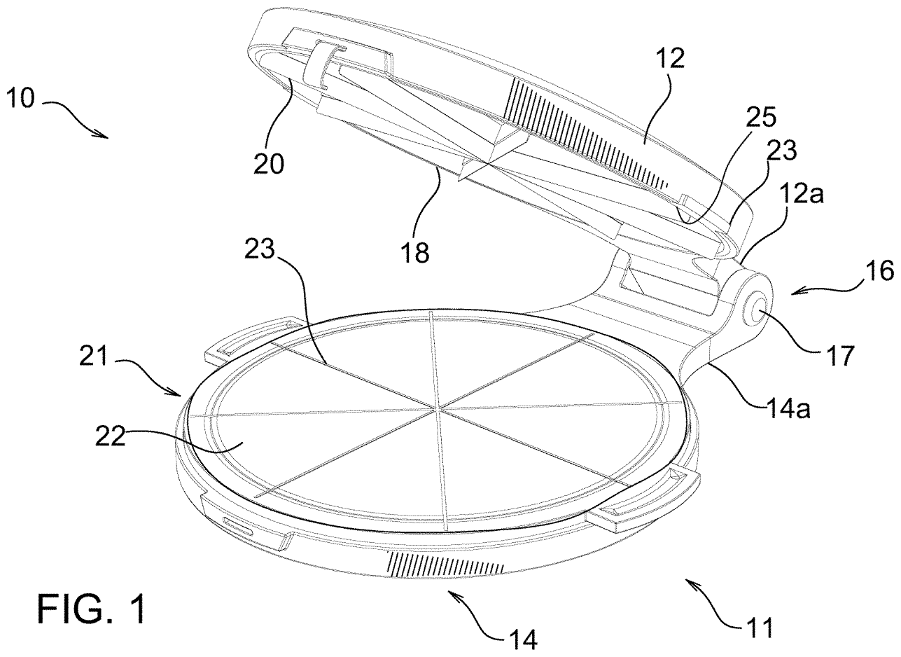

As used herein, terms referring to a direction or a position relative to the orientation of the food cutting device, such as but not limited to “vertical,” “horizontal,” “top,” “bottom,” “above,” or “below,” refer to directions and relative positions with respect to the food cutting device's orientation in its normal intended operation, as indicated in FIG. 1. Thus, for instance, the terms “vertical” and “top” refer to the vertical orientation and relative upper position in the perspective of FIG. 1, and should be understood in that context, even with respect to a food cutting device that may be disposed in a different orientation.

Further, the term “or” as used in this application and the appended claims is intended to mean an inclusive “or” rather than an exclusive “or.” That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B. In addition, the articles “a” and “and” as used in this application and the appended claims should generally be construed to mean “one or more” unless specified otherwise or clear from the context to be directed to a singular form. Throughout the specification and claims, the following terms takes at least the meanings explicitly associated herein, unless the context dictates otherwise. The meanings identified below do not necessarily limit the terms, but merely provide illustrative examples for the terms. The meaning of “a,” “and,” and “the” may include plural references, and the meaning of “in” may include “in” and “on.” The phrase “in one embodiment,” as used herein, does not necessarily refer to the same embodiment, although it may.

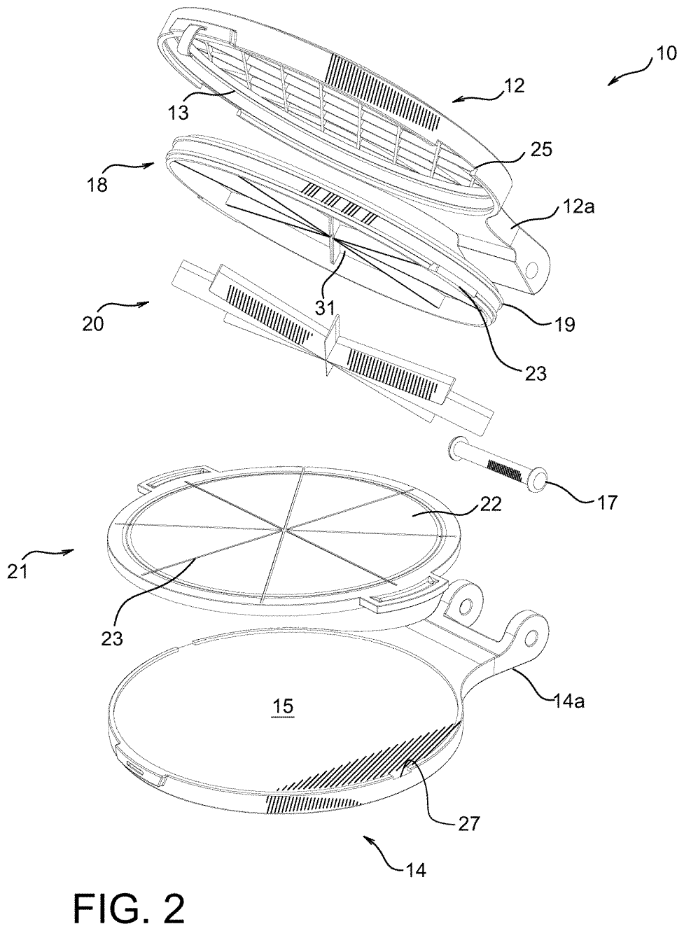

Referring now to FIGS. 1 and 2, a pizza cutting device 10 in accordance with the present disclosure includes a housing 11 having a top portion 12 that is pivotably connected to a bottom portion 14 by a hinge 16. As shown, the hinge 16 is formed by a pin 17 that pivotably connects an arm 12a of the top portion 12 of the housing with an arm 14a of the bottom portion 14 of the housing. The top portion 12 includes a recess 13 that is configured to receive a cutting assembly 18 therein in a snap-fit. The bottom portion 14 includes a top surface 15 that is configured to receive a cutting board 21 thereon.

As shown, cutting assembly 18 includes a shell 19 with a plurality of elongated blades 20 that extend radially-outwardly from a center of the shell 19 and extend downwardly therefrom. As shown, the blades 20 are rigidly attached to the shell 19 so that when the top portion 12 of the housing 11 is pivoted downwardly with respect to the bottom portion 14 of the housing 11, the blades 20 makes contact with a top surface 22 of a cutting board 21 that is disposed on the bottom portion 14 of the housing 11. As such, any food item disposed on the top surface 22 of a cutting board 21 is sliced into individual portions by the cutting assembly 18.

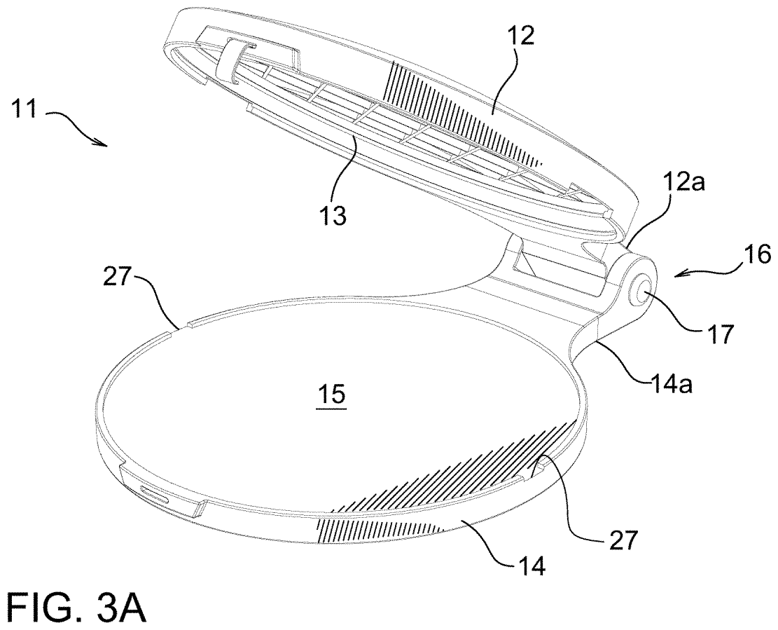

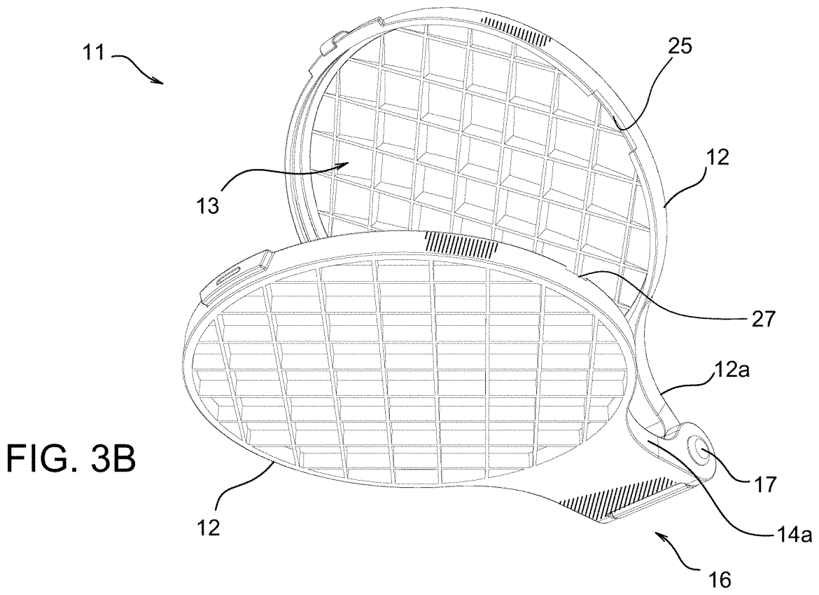

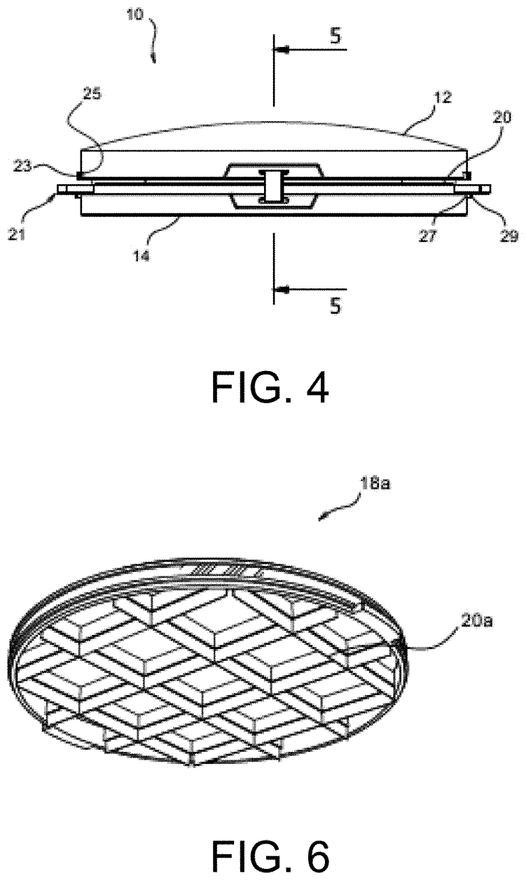

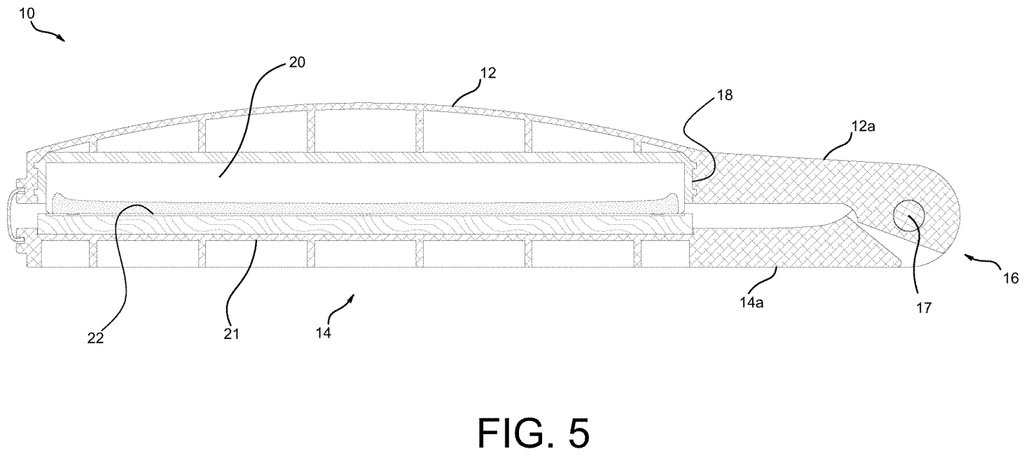

Referring additionally to FIGS. 3A and 3B, in the embodiment shown, the shell 19 of the cutting assembly 18 includes a pair of tabs 23 that are received in a corresponding set of recesses 25 formed in the top portion 12 of the housing 11 in a snap-fit. Not only does the interaction of the tabs 23 within the recesses 25 retain the cutting assembly 18 within the top portion 12 of the housing 11, the interaction insures that the blade assembly 18 is properly aligned with the cutting board 21. Specifically, proper alignment between the cutting assembly 18 and the cutting board 21 insures that the blades 20 are properly aligned with the corresponding grooves 23 on the cutting board 21. Note, grooves 23 may or may not be provided on the cutting board 21, i.e., the top surface of the cutting board 21 may be a smooth surface. Similarly to the cutting assembly 18, the cutting board 21 includes a pair of tabs 29 that are received in recesses 27 formed on the bottom portion 14 of the housing 11 to insure the cutting board properly aligned on the bottom portion 14 of housing 11.

Preferably, the blades 20 of the cutting assembly 18 are evenly spaced so that the individual portions of the food items being cut are evenly sized as long as the food item is properly positioned on the top surface 22 of the cutting board 21. Referring additionally to FIG. 6, in alternate embodiments, the cutting assembly 18a may include blades 20a having configurations other than the traditional pie-shape, such as square. Numerous blade configurations are possible and are intended to be included in the present disclosure. Additionally, in alternate embodiments, the blades 20 may be spaced unevenly, for example, so that one side of the food item is sliced into portions for adults whereas the other side of the food item is sliced into portions that are more suitable for children.

Preferably, both the bottom surface 31 of the cutting assembly shell 19 and the top surface 22 of the cutting board 21 may be non-stick surfaces to facilitate removal of food items and cleaning. Moreover, in alternate embodiments, the top portion 12 of the housing may include a recess so that the blades of the cutting assembly can be selectively positioned between a first extended position for cutting, and a second retracted position for after the food item has been cut into individual pieces. For example, once the food item (i.e. pizza) has been sliced, the blades of the cutting assembly 18 may be retracted into the top portion 12 of the housing 11 so that the blades 20 are no longer exposed, thereby increasing the safety of the user. A J-lock device (not shown) on the top portion 12 of the housing 11 may be used to move and secure the cutting assembly 18 between the first and second positions. Preferably, the elongated blades 20 extend downwardly from a base plate, similar to bottom surface 31 of the cutting assembly 18, that is disposed within the top portion and is spring-loaded into the second (retracted) position.

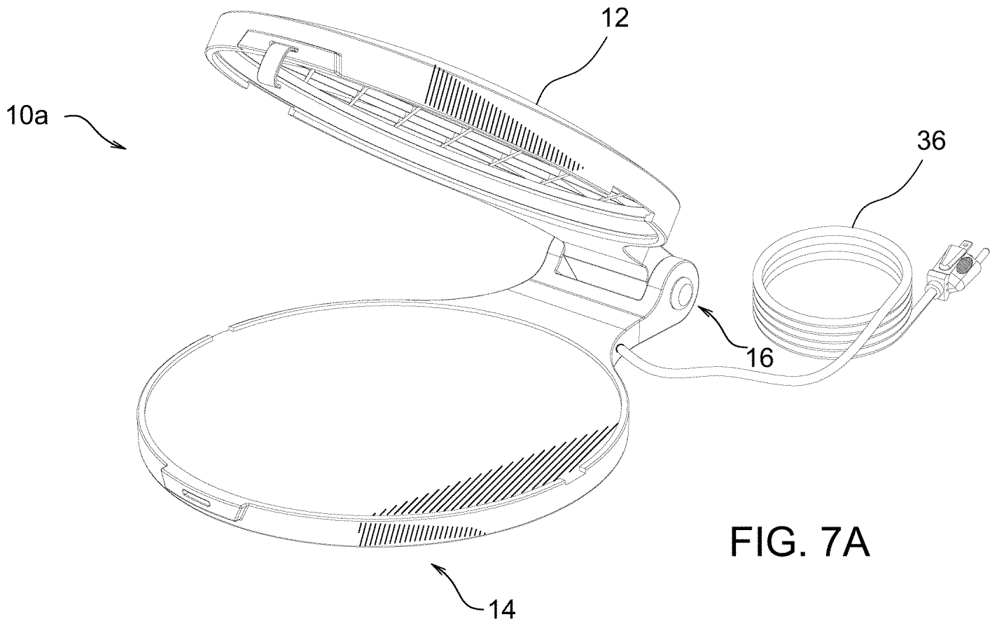

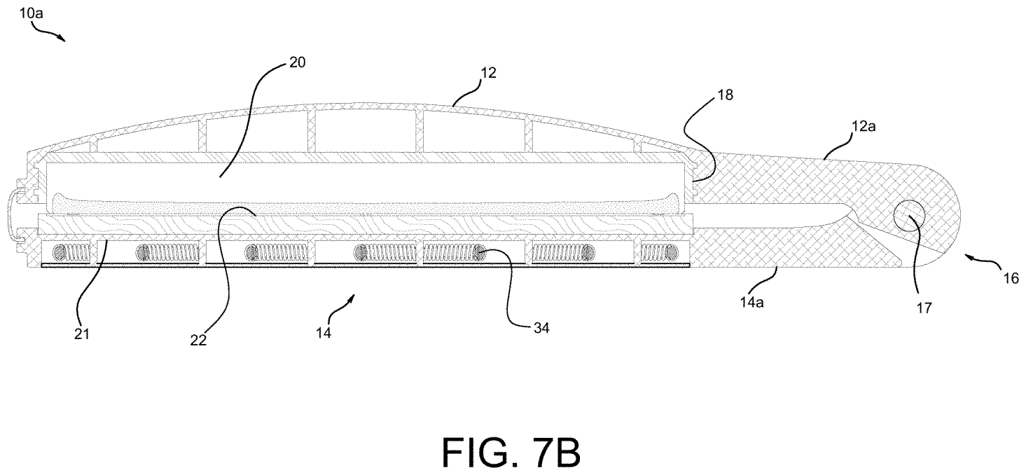

Referring now to FIGS. 7A and 7B, in an alternate embodiment, either one or both of the top portion 12 and the bottom portion 14 of the housing 11 of the cutting device 10a includes heating elements 34. As such, the cutting device 10 is suited for use in buffet settings, such as in restaurants, as well as for personal use. A power cord 36 allows the cutting device 10a to be used at numerous locations as long as an electrical outlet is present. Preferably, a thermostat (not shown) allows a user to select a desired level of heating provided by the heating elements 34. As well, alternate embodiments of the cutting assembly may include alternately configured housings, such as rectangular, and blades to allow for cutting alternately shaped food items.

While one or more preferred embodiments of the invention are described above, it should be appreciated by those skilled in the art that various modifications and variations can be made in the present invention without departing from the scope and spirit thereof. It is intended that the present invention cover such modifications and variations as come within the scope and spirit of the appended claims and their equivalents.

1. A pizza cutting device for cutting a food item into a plurality of individual portions, comprising:
a base portion including a bottom panel with a substantially-planar top surface;
a top portion including a housing and a cutting assembly including a plurality of elongated blades, the top portion being pivotably-connected to the base portion, the top portion being movable between an open position and a closed position,
wherein the cutting assembly is movable between a first position in which the blades of the cutting assembly extend outwardly from the housing, and a second position in which the blades are disposed entirely within the housing.

2. The cutting device as in claim 1, wherein a bottom edge of each blade contacts the top surface of the bottom panel when the top portion is in the closed position.

3. The cutting device as in claim 2, wherein:
the housing of the top portion further comprises a top wall and a side wall extending downwardly therefrom, the cutting assembly further comprises a base plate, the plurality of blades extending downwardly therefrom, and a spring assembly is disposed in housing so that the cutting assembly is spring-loaded toward the second position.

4. The cutting device as in claim 3, the top portion further comprising a J-lock assembly formed by at least one lock slot formed in a side wall of the top portion, and at least one lock handle disposed on the lock plate so that the at least one lock handle extends outwardly through the lock slot, wherein when the lock handle is adjacent a first end of the lock slot the cutting assembly is in the first position and when the lock handle is adjacent the second end of the lock slot the cutting assembly is in the second position.

5. The cutting device as in claim 3, wherein the J-lock assembly further comprises a plurality of lock slots and a plurality of lock handles extending outwardly therethrough.

6. The cutting device as in claim 3, wherein the top portion further comprises a top panel, the top panel defining a plurality of elongated slots, the plurality of blades being selectively extendable therethrough.

7. The cutting device as in claim 3, wherein the spring assembly is disposed between the top panel of the top portion and the base plate of the cutting assembly.

8. The cutting device as in claim 2, wherein the top surface of the bottom panel of the base portion defines a plurality of grooves, wherein each groove is configured to receive a bottom edge of a corresponding blade therein.

9. The cutting device as in claim 6, wherein a bottom surface of the top panel is a non-stick surface.

10. The cutting device as in claim 1, wherein one of the top portion and the base portion includes a heating element.
